(19) United States
(12) Patent Application Publication
(10) Pub. No.: US 2005/0190902 A1
(43) Pub. Date: Sep. 1, 2005

(54) Network support for billing customer calls according to tailored billing lists

(76) Inventors: David S. Benco, Winfield, IL (US); Sandra Lynn True, St. Charles, IL (US)

Correspondence Address: Docket Administrator (Room 3J-219);Lucent Technologies Inc., 101 Crawfords Corner Road, Holmdel, NJ, 07733-3030, US

(21) Appl. No.: 10/789,048

(22) Filed: Feb. 27, 2004

(51) Int. Cl. H04M 15/00; H04M 11/00

(52) U.S. Cl. 379/114.21; 379/114.23; 455/406

(57) ABSTRACT

Methods are disclosed for billing customer calls according to predefined billing lists. The billing lists may be consulted during or after a call to determine if the customers initiating or receiving the call have authorized alternative billing treatment. The alternative billing treatment may comprise, for example, billing both call legs of a wireless call to a single party (e.g. the calling or called party) or charging monetary charges of a wireline call to the called party without invoking operator services.

### FIELD OF THE INVENTION

This invention relates generally to telecommunication networks and, more particularly, to a billing feature for wireless and/or wireline telecommunication networks.

### BACKGROUND OF THE INVENTION

Communication systems are well known in which a calling party (using, for example, a wireless or wireline phone) may initiate a call to a called party (also using, for example, a wireless or wireline phone). Typically, the call is initiated by the calling party dialing a directory number associated with the called party phone, causing a network infrastructure to set up communication resources for the call and ring the called party phone. Once the called party answers the phone, an active call session is established and the parties may communicate via the communication resources established for the call. Most typically, the communication is a voice communication, but other forms of communication (e.g., data, video, fax, etc.) are also known.

The communication resources established for the calling and called parties during a call are sometimes referred to as call “legs.” The typical call between two parties includes two legs, the first leg comprising the resources between the calling party phone and a network switching element (“switch”) and the second leg comprising the resources between the switch and the called party phone. As will be appreciated, additional call legs may exist for certain calls. The manner of billing customers generally depends on the type of call.

For wireless calls, the customary practice is to bill customers having participated in a call whether they initiated or received the call. Thus, for a wireless call having two legs, the calling party is customarily billed for the first leg and the called party is billed for the second leg. Further, wireless service providers usually bill customers for airtime minutes in relation to a service plan. Under such plans, the customer often receives a certain amount of “free” airtime minutes in return for a base fee; and airtime minutes exceeding the plan are charged at a per-minute rate. Thus, the practice of billing a customer for a wireless call may or may not yield a monetary charge to the customer; but even if the call is free there is an “airtime charge” associated with a reduction of free airtime minutes available for future calls. For wireline calls, the customary practice is to bill the calling party for both call legs, although a customer originating a call may invoke certain operator services to change the customary billing. As an example, a customer may place a “collect” call to effect charging the called party for both call legs. As is well known, additional charges may apply for invoking operator services.

A problem that arises is that the customary billing practices for wireless or wireline calls may not be suitable for all customers or all situations. As an example, in the case of wireless calls, a calling party may wish to absorb charges for both call legs so as not to burden the called party with airtime charges; or conversely, a called party may wish to absorb charges for both call legs from a calling party. In the case of wireline calls, a calling party may wish to invoke alternative billing without invoking operator services; or a called party may wish to absorb charges without relying on the calling party invoking operator services. Accordingly, there is a need to provide an alternative to customary billing practices for certain customers and/or certain calls. Advantageously, alternative billing will be established according to tailored billing lists established by individual subscribers. The present invention is directed to addressing this need.

### SUMMARY OF THE INVENTION

This need is addressed and a technical advance is achieved in the art by a feature whereby a network device consults tailored billing list(s) of customer(s) to establish billing for a call. Without limitation, the tailored billing lists may provide alternatives to customary billing practices including, for wireless calls, charging both call legs to a single party; and for wireline calls, charging the call to a called party without the calling party invoking operator services.

In one embodiment, there is provided a method for billing a customer call according to calling and called party billing lists wherein the billing lists are consulted during the customer call. After connecting a call between a calling party and called party, a calling party billing list is consulted to determine whether the calling party has authorized alternative billing treatment for the call. If the calling party has authorized alternative billing treatment, a billing record is generated to bill the calling party according to the alternative billing treatment. The billing treatment may comprise, for example, charging airtime minutes or monetary charges for both call legs of a wireless call to the calling party. Optionally, a message may be sent to inform the parties that the call will be billed to the calling party. If the calling party has not authorized alternative billing treatment, a called party billing list is consulted to determine whether the called party has authorized alternative billing treatment for the call. If the called party has authorized alternative billing treatment, a billing record is generated to bill the called party according to the alternative billing treatment. The billing treatment may comprise, for example, charging airtime minutes or monetary charges for both call legs of a wireless call to the called party; or charging monetary charges of a wireline call to the called party. Optionally, a message may be sent to inform the parties that the call will be billed to the called party. If neither the calling party nor called party has authorized alternative billing treatment, a billing record is generated for the call according to customary practice.

In another embodiment, there is provided a method for billing a customer call according to calling and called party billing lists wherein the billing lists are consulted after completion of a customer call. After receiving billing information associated with a call between a calling party and called party, a calling party billing list is consulted to determine whether the calling party has authorized alternative billing treatment for the call. If the calling party has authorized alternative billing treatment, a billing record is generated or an existing billing record is amended to bill the calling party according to the alternative billing treatment. The billing treatment may comprise, for example, charging airtime minutes or monetary charges for both call legs of a wireless call to the calling party. If the calling party has not authorized alternative billing treatment, a called party billing list is consulted to determine whether the called party has authorized alternative billing treatment for the call. If the called party has authorized alternative billing treatment, a billing record is generated or an existing billing record is amended to bill the called party according to the alternative billing treatment. The billing treatment may comprise, for example, charging airtime minutes or monetary charges for both call legs of a wireless call to the called party; or charging monetary charges of a wireline call to the called party. If neither the calling party nor called party has authorized alternative billing treatment, a billing record is generated for the call according to customary practice.

### BRIEF DESCRIPTION OF THE DRAWINGS

The foregoing and other advantages of the invention will become apparent upon reading the following detailed description and upon reference to the drawings in which:

FIG. 1 is a block diagram of a communication system in which embodiments of the present invention may be implemented;

FIG. 2 is a flowchart of a method for billing a customer call according to calling and called party billing lists according to an embodiment of the present invention wherein the billing lists are consulted during the customer call; and

FIG. 3 is a flowchart of a method for billing a customer call according to calling and called party billing lists according to an embodiment of the present invention wherein the billing lists are consulted after the customer call is completed.

### DESCRIPTION OF THE PREFERRED EMBODIMENT(S)

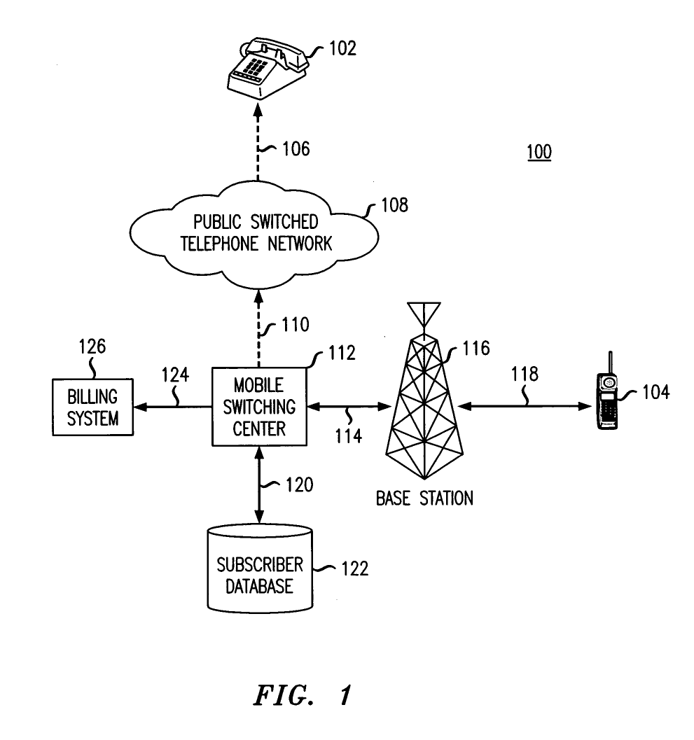

FIG. 1 shows a communication system 100 according to an exemplary embodiment of the invention that is operable to support billing of customer calls according to tailored billing lists. The customer calls may be initiated or received by wireline or wireless phones, fax machines, personal digital assistants (PDAs), personal computers or generally any communication device that is capable of initiating or receiving calls. For convenience, only one each of a wireline device 102 and wireless device 104 is shown. However, as will be appreciated, the communication system 100 is operable to support calls involving virtually any number or combination of wireless and wireline devices.

The wireline device 102 is connected by link 106 to a network 108 (as shown, the Public Switched Telephone Network (PSTN)). The network 108 may be implemented using any appropriate transmission, switching and routing technologies, including but not limited to Internet Protocol (IP) and Asynchronous Transfer Mode (ATM) technologies. The network 108 is connected by link 110 to a switching element 112 (as shown, a mobile switching center (MSC)). The switching element 112 is connected by link 114 to a base station 116, which is connected by wireless link 118 to the wireless device 104. The wireless link 118 may implement air interface technologies including but not limited to, CDMA, TDMA, GSM, UMTS or IEEE 802.11.

The switching element 112 is a call processing control entity that routes calls, as may be appropriate, between calling and called party devices. The switching element 112 is a functional element that may reside in a single switch or may be distributed among multiple switches and/or locations. In the case where the switching element 112 comprises an MSC, the MSC includes home location register (HLR) and visitor location register (VLR) functionality to monitor the location of mobile units as they roam between different cell sites or between different service areas controlled by different MSCs. The MSC may comprise, for example, an AUTOPLEX™ switching system, available from Lucent Technologies, Inc. Alternatively or additionally, the switching element 112 may comprise a central office switch (not shown), such as a 5ESS® switching system, available from Lucent Technologies, Inc. In either case, the switching element 112 includes a memory and processor (not shown), for storing and executing software routines for processing and switching calls and for providing various call features to calling or called parties. The switching element 112 may be configured for operation with generally any suitable circuit, cell, or packet switching technology.

As shown, the switching element 112 is further connected by link 120 to a subscriber database 122 and by link 124 to a billing system 126. Links 120, 124 (as well as links 106, 110, 114) are logical links that may be physically realized, without limitation, by conventional subscriber lines, Asynchronous Transfer Mode (ATM) lines, ISDN lines, Ethernet LAN or WAN, wireless links, and the like.

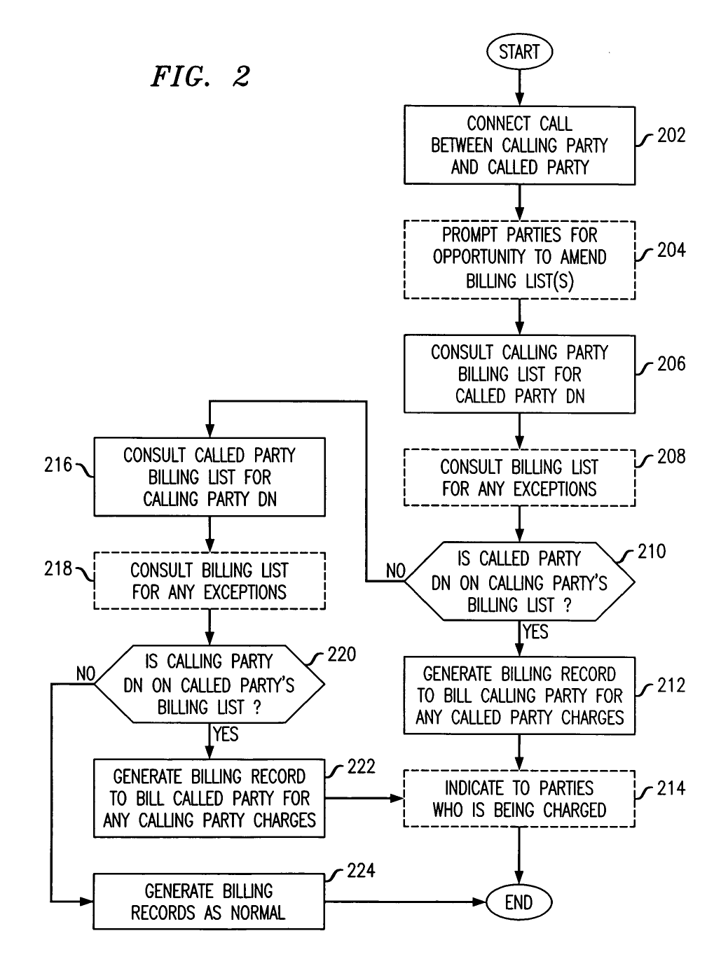

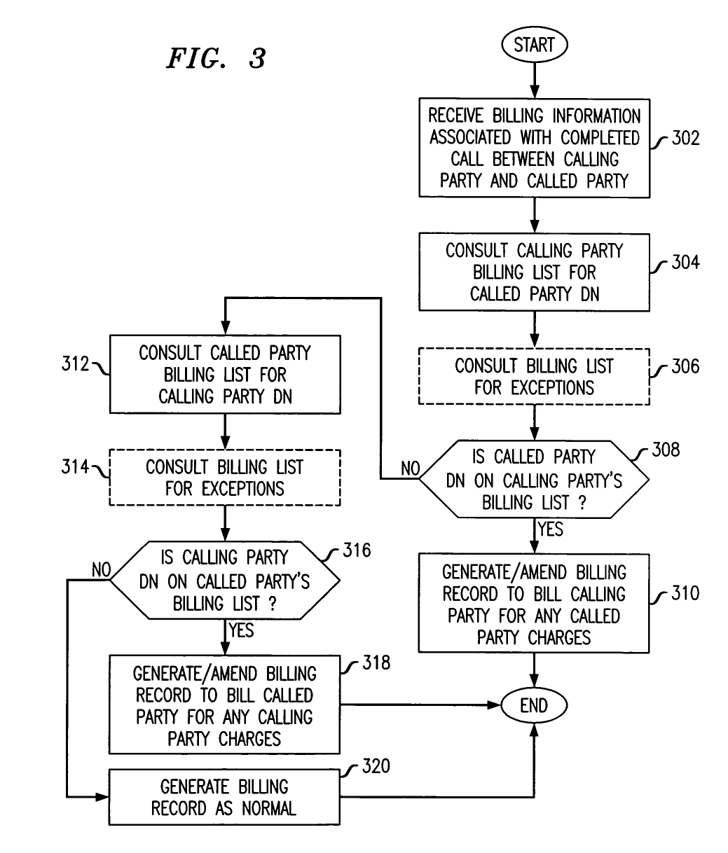

In one embodiment, the subscriber database 122 includes information such as directory numbers and billing lists associated with various subscribers. The billing lists may include, for example, lists of directory numbers for which a subscriber is willing to accept charges other than customary charges. For example, in the case of wireless calls, the billing list may indicate a list of numbers for which a subscriber is willing to accept charges (either monetary or “airtime” charges) for both call legs. Upon connecting a call (FIG. 2) or after completion of a call (FIG. 3), the switching element 112 or billing system 126 consults the billing database to determine how the call is to be charged; and the billing system 126 generates billing records for the call as may be appropriate. Alternatively, the billing lists may reside within the billing system 126 rather than the subscriber database.

It is contemplated that billing list entries (i.e., directory numbers, and/or billing treatment associated with particular directory numbers) may be defined by customers at time of service provisioning of a wireline or wireless device 102, 104 or at time of subscription to an “alternative billing” service. Advantageously, the billing list entries are modifiable via an appropriate user interface including, without limitation, a web page, customer service center or responsive to prompting during calls. In one embodiment, the billing list includes, for each participating subscriber, one or more directory numbers for which alternative billing is authorized. The billing list may also include feature bits, “flags” or the like that indicate billing treatment options or features applicable to the respective directory numbers. Example options include, without limitation, authorization for dual billing (i.e., assuming charges for multiple call legs) for wireless calls and authorization to assume charges for wireline calls. Example features include, without limitation, an announcement feature that informs the parties who is being charged; or an “exception” feature that allows parties to more finely tailor the alternative billing treatment. Exceptions may include, for example and without limitation, a per-call charge limit or aggregate charge limit; or a restriction on what types of calls are authorized for alternative billing.

Turning now to FIG. 2, there is shown a flowchart of a method that may be implemented for billing a customer call according to calling and called party billing lists, wherein the billing lists are consulted during the customer call. The steps of FIG. 2 are implemented using stored software routines within the switching element 112 and/or billing system 126.

At step 202, the switching element 112 connects a call between a calling and called party. The method presumes that coincident to connecting the call, the switching element 112 identifies the directory number of the calling and called party devices. Optionally, at step 204, the switching element plays (or causes to be played) an announcement prompting one or both parties for an opportunity to amend their billing lists. In such manner, a party may add or remove the other party from their billing list effective as of the present call.

At step 206, the switching element 112 consults the calling party billing list for the called party directory number. Generally, the presence of the called party directory number in the calling party billing list indicates that the calling party has authorized alternative billing treatment for the call. For example, the billing list may indicate that dual billing is authorized for wireless calls, i.e., the calling party is charged for both call legs to the called party directory number. (The billing list might also indicate similar treatment for wireline calls, although it is already the customary practice to assess wireline phone charges to the calling party.)

Optionally, the billing list may indicate various exceptions associated with the authorized billing treatments. In such case, the switching element 112 consults the calling party billing list for exceptions at step 208. For example, in the case where both call legs are indicated as chargeable to the calling party, exceptions may apply to limit the charges to a predetermined amount, which may comprise a per-call amount or an aggregate amount. As another example, an exception may provide for billing airtime minutes if applicable but not monetary charges. Still another example may provide for billing for certain types of calls (e.g., voice calls but not short message service, etc.).

At step 210, it is determined whether the calling party has authorized alternative billing treatment for the call. As has been described, this is determined in one embodiment by the presence or absence of the called party directory number in the calling party billing list; and optionally, depending on applicable exceptions. To avoid confusion, it is presumed for purposes of explanation that exceptions are not considered (or do not apply) at step 210. Thus, a positive determination is reached at step 210 if the called party directory number is present in the calling party billing list; and a negative determination is reached at step 210 if the called party directory number is not present in the calling party billing list.

Responsive to a positive determination at step 210, the billing system at step 212 generates a billing record accordingly, to bill the calling party for any charges that would customarily be charged to the called party. Thus, in the example of a wireless call where the calling party billing list includes the directory number of the called party, and the billing list indicates that the dual billing feature is active, the billing system 126 will generate a record that debits airtime minutes and/or charges for both sides of the call to the calling party. Optionally, at step 214, the switching element plays (or causes to be played) an announcement informing the parties who is accumulating airtime minutes or paying monetary charges for the call. As will be appreciated, the step of informing the parties might also be accomplished by a text indication, tone, distinctive ring, or the like.

Responsive to a negative determination at step 210, the switching element at step 216 consults the called party billing list for the calling party directory number; optionally, at step 218, consults the called party billing list for exceptions; and at step 220, determines whether the called party has authorized alternative billing treatment for the call. Generally, steps 216, 218, 220 (all relating to the called party billing list) are mirror images of steps 206, 208, 210 (relating to the calling party billing list). To avoid unnecessary repetition, it suffices to state that a positive determination at step 220 indicates that the called party has authorized alternative billing treatment for the call. This presumes that the calling party directory number is present in the called party billing list and that exceptions either are not considered or do not apply.

For example, the billing list may indicate that for wireless calls from the calling party directory number, airtime minutes and/or monetary charges for both call legs should be charged to the called party. The billing list might also indicate for wireline calls, that phone charges should be assessed to the called party without the need for the calling party to invoke a collect call.

Responsive to a positive determination at step 220, the billing system at step 222 generates a billing record accordingly, to bill the called party for any charges that would customarily be charged to the calling party. Thus, in the example of a wireless call, the billing system 126 may generate a record that charges both call legs to the called party; and in the case of a wireline call, the billing system may assess phone charges to the called party which do not include charges for operator assistance. Optionally, at step 214, the switching element plays (or causes to be played) an announcement informing the parties who is being charged for the call.

Responsive to a negative determination at step 220, the billing system 126 will generate a billing record according to customary-practice at step 224. Thus, in the example of a wireless call, a negative determination at step 220 indicates that alternative billing treatment does not apply to the call; and the billing system will charge both the calling party and called party for call legs as normal. In the case of a wireline call, a negative determination will cause the billing system to assess phone charges to the calling party as normal.

Now turning to FIG. 3, there is shown a flowchart of a method that may be implemented for billing a customer call according to calling and called party billing lists, wherein the billing lists are consulted after the customer call is completed. The steps of FIG. 3 are implemented using stored software routines within the billing system 126.

At step 302, the billing system 126 receives billing information associated with a completed call between a calling and called party. The method presumes that the billing information includes the directory number of the calling and called party devices and indicia of resources used, airtime minutes and the like that enable the billing system to generate billing records for the call. The billing records may be generated before or after consulting the billing lists. It is contemplated that if billing records are generated before consulting the billing lists, the billing records are subject to amendment after consulting the billing lists.

At step 304, the billing system 126 consults the calling party billing list for the called party directory number. Generally, as has been described in relation to FIG. 2, the presence of the called party directory number in the calling party billing list indicates that the calling party has authorized alternative billing treatment for the call. Advantageously, the billing list also indicates the nature of authorized billing treatment(s). For example, the billing list may indicate that for wireless calls to the called party directory number, airtime minutes and/or monetary charges for both call legs should be charged to the calling party. (The billing list might also indicate similar treatment for wireline calls, although it is already the customary practice to assess wireline phone charges to the calling party.)

Optionally, the billing list may indicate various exceptions associated with the authorized billing treatments. In such case, the billing system 126 consults the calling party billing list for exceptions at step 306. For example, in the case where both call legs are indicated as chargeable to the calling party, exceptions may apply to limit the charges to a predetermined amount, which may comprise a per-call amount or an aggregate amount. As another example, an exception may provide for billing airtime minutes if applicable but not monetary charges. Still another example may provide for billing for certain types of calls (e.g., voice calls but not short message service, etc.).

At step 308, it is determined whether the calling party has authorized alternative billing treatment for the call. As has been described, this is determined in one embodiment by the presence or absence of the called party directory number in the calling party billing list; and optionally, depending on applicable exceptions. It is presumed for purposes of explanation that exceptions are not considered (or do not apply) at step 308. Thus, a positive determination is reached at step 308 if the called party directory number is present in the calling party billing list; and a negative determination is reached at step 308 if the called party directory number is not present in the calling party billing list.

Responsive to a positive determination at step 308, the billing system at step 310 generates a billing record or amends a previous billing record, as may be appropriate, to bill the calling party for any charges that would customarily be charged to the called party. Thus, in the example of a wireless call where the calling party billing list includes the directory number of the called party, and the billing list indicates that both legs are chargeable to the calling party, the billing system 126 will generate a record that charges both call legs to the calling party.

Responsive to a negative determination at step 308, the billing system at step 312 consults the called party billing list for the calling party directory number; optionally, at step 314, consults the called party billing list for exceptions; and at step 316, determines whether the called party has authorized alternative billing treatment for the call. Generally, steps 312, 314, 316 (all relating to the called party billing list) are mirror images of steps 304, 306, 308 (relating to the calling party billing list). To avoid unnecessary repetition, it suffices to state that a positive determination at step 316 indicates that the called party has authorized alternative billing treatment for the call. This presumes that the calling party directory number is present in the called party billing list and that exceptions either are not considered or do not apply.

For example, the billing list may indicate that for wireless calls from the calling party directory number, airtime minutes and/or monetary charges for both call legs should be charged to the called party. The billing list might also indicate for wireline calls, that phone charges should be assessed to the called party without the need for the calling party to invoke a collect call.

Responsive to a positive determination at step 316, the billing system at step 318 generates a billing record or amends a previous billing record, as may be appropriate, to bill the called party for any charges that would customarily be charged to the calling party. Thus, in the example of a wireless call, the billing system 126 may generate or amend a record to yield charges to the called party for multiple call legs; and in the case of a wireline call, the billing system may generate or amend a record to assess phone charges to the called party which do not include charges for operator assistance.

Responsive to a negative determination at step 316, the billing system 126 will generate a billing record according to customary practice at step 320. Thus, in the example of a wireless call, a negative determination at step 316 indicates that alternative billing treatment does not apply to the call; and the billing system will charge both the calling party and called party for call legs as normal. In the case of a wireline call, a negative determination will cause the billing system to assess phone charges to the calling party as normal.

The specific exemplary embodiments of the present invention have been described with some aspects simplified or omitted. Those skilled in the art will appreciate variations from these embodiments that fall within the scope of the invention. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method comprising the steps of:
connecting a call between a calling party and called party;
consulting a calling party billing list to determining whether the calling party has authorized alternative billing treatment for the call;
if the calling party has authorized alternative billing treatment, generating a billing record to bill the calling party according to the alternative billing treatment;
if the calling part has not authorized alternative billing treatment:
consulting a called party billing list to determining whether the called party has authorized alternative billing treatment for the call; and
if the called party has authorized alternative billing treatment, generating a billing record to bill the called party according to the alternative billing treatment.

2. The method of claim 1, further comprising, if the calling party has authorized alternative billing treatment:
sending a message to one or both of the calling party and called party indicating that the calling party is being billed for the call according to the alternative billing treatment.

3. The method of claim 1, wherein the call comprises a wireless call having a plurality of call legs, the alternative billing treatment comprising an authorization to charge one or more of airtime minutes and monetary charges for each of the call legs to the calling party.

4. The method of claim 1, wherein the step of consulting the calling party billing list comprises:
identifying a directory number associated with the called party, defining a called party directory number;
determining if the called party directory number is present in the calling party billing list, a presence of the called party directory number in the calling party billing list indicating that the calling party has authorized alternative billing treatment.

5. (canceled)

6. The method of claim 1, further comprising, if the called party has authorized alternative billing treatment:
sending a message to one or both of the calling party and called party indicating that the called party is being billed for the call according to the alternative billing treatment.

7. The method of claim 1, wherein the call comprises a wireless call having a plurality of call legs, the alternative billing treatment comprising an authorization to charge one or more of airtime minutes and monetary charges for each of the call legs to the called party.

8. The method of claim 1, wherein the call comprises a wireline call, the alternative billing treatment comprising an authorization to bill monetary charges associated with the wireline call to the called party.

9. The method of claim 1, wherein the step of consulting the called party billing list comprises:
identifying a directory number associated with the calling party, defining a calling party directory number;
determining if the calling party directory number is present in the called party billing list, a presence of the calling party directory number in the called party billing list indicating that the called party has authorized alternative billing treatment.

10. The method of claim 1, further comprising, if the calling party has not authorized alternative billing treatment, generating a billing record for the call according to customary practice.

11. A method comprising the steps of:
receiving billing information associated with a call between a calling party and called party;
consulting a calling party billing list to determining whether the calling party has authorized alternative billing treatment for the call;
if the calling party has authorized alternative billing treatment, generating a billing record to bill the calling party according to the alternative billing treatment;
if the calling part has not authorized alternative billing treatment:
consulting a called parts billing list to determining whether the called party has authorized alternative billing treatment for the call; and
if the called party has authorized alternative billing treatment, generating a billing record to bill the called party according to the alternative billing treatment.

12. The method of claim 11, wherein the call comprises a wireless call having a plurality of call legs, the alternative billing treatment comprising an authorization to charge one or more of airtime minutes and monetary charges for each of the call legs to the calling party.

13. The method of claim 11, wherein the step of consulting the calling party billing list comprises:
identifying a directory number associated with the called party, defining a called party directory number;
determining if the called party directory number is present in the calling party billing list, a presence of the called party directory number in the calling party billing list indicating that the calling party has authorized alternative billing treatment.

14. (canceled)

15. The method of claim 11, wherein the call comprises a wireless call having a plurality of call legs, the alternative billing treatment comprising an authorization to charge one or more of airtime minutes and monetary charges for each of the call legs to the called party.

16. The method of claim 11, wherein the call comprises a wireline call, the alternative billing treatment comprising an authorization to bill monetary charges associated with the wireline call to the called party.

17. The method of claim 11, wherein the step of consulting the called party billing list comprises:
identifying a directory number associated with the calling party, defining a calling party directory number;
determining if the calling party directory number is present in the called party billing list, a presence of the calling party directory number in the called party billing list indicating that the called party has authorized alternative billing treatment.

18. The method of claim 11, further comprising, if the calling party has not authorized alternative billing treatment, generating a billing record for the call according to customary practice.

19. A method comprising the steps of:
connecting a call between a calling party and called party;
consulting a called party billing list to determining whether the called party has authorized alternative billing treatment for the call;
if the called party has authorized alternative billing treatment, generating a billing record to bill the called party according to the alternative billing treatment;
if the called party has not authorized alternative billing treatment:
consulting a calling party billing list to determining whether the calling party has authorized alternative billing treatment for the call; and
if the calling party has authorized alternative billing treatment, generating a billing record to bill the calling party according to the alternative billing treatment.

20. A method comprising the steps of:
receiving billing information associated with a call between a calling party and called party;
consulting a called party billing list to determining whether the called party has authorized alternative billing treatment for the call;
if the called party has authorized alternative billing treatment, generating a billing record to bill the called party according to the alternative billing treatment;
if the called party has not authorized alternative billing treatment:
consulting a calling party billing list to determining whether the calling party has authorized alternative billing treatment for the call; and
if the calling party has authorized alternative billing treatment, generating a billing record to bill the calling party according to the alternative billing treatment.
